(19) United States
(12) Patent Application Publication
(10) Pub. No.: US 2016/0131677 A1
(43) Pub. Date: May 12, 2016

(54) MOTION PATTERN BASED EVENT DETECTION USING A WEARABLE DEVICE

(71) Applicant: INTERNATIONAL BUSINESS MACHINES CORPORATION, Armonk, NY (US)

(72) Inventors: JAMES E. BOSTICK, Austin, TX (US); John M. Ganci, JR., Cary, NC (US); Sarbajit K. Rakshit, Kolkata (IN); Craig M. Trim, Sylmar, CA (US)

(73) Assignee: INTERNATIONAL BUSINESS MACHINES CORPORATION, Armonk, NY (US)

(21) Appl. No.: 14/536,866

(22) Filed: Nov. 10, 2014

(51) Int. Cl. G01P 13/00

(52) U.S. Cl. CPC G01P 13/00

(57) ABSTRACT

A method, system, and computer program product for motion pattern based event detection using a wearable device are provided in the illustrative embodiments. During a period beginning at a first time, using the wearable device, a pattern of a motion is detected, the motion being in body part of a user on which the wearable device is worn. The pattern is recorded for the period, the pattern occurring over at least the period. A collaborative information is received from the wearable device, the collaborative information defining a characteristic of the pattern. The pattern and the collaborative information are associated with an event. During a second period beginning at a second time, the pattern and the collaborative information are detected. Responsive to detecting at the second time, an action associated with the event is performed.

### TECHNICAL FIELD

The present invention relates generally to a method, system, and computer program product for using a wearable device. More particularly, the present invention relates to a method, system, and computer program product for motion pattern based event detection using a wearable device.

### BACKGROUND

Wireless communications (mobile communications) enable users to perform a variety of tasks using their mobile devices. An ever increasing number of applications is available for the wireless data processing systems, wireless data communication devices, or wireless computing platforms (collectively and interchangeably, “mobile device” or “mobile devices”). For example, many mobile devices not only allow the users to make voice calls, but also exchange emails and messages, access remote data processing systems, and perform web-based interactions and transactions.

Wearable devices are a category of mobile devices. A wearable device is essentially a mobile device, but has a form-factor that is suitable for wearing the device on a user's person. A user can wear such a device as an article of clothing, clothing or fashion accessory, jewelry, a prosthetic or aiding apparatus, an item in an ensemble, an article or gadget for convenience, and the like. Some examples of presently available wearable devices include, but are not limited to, smart watches, interactive eyewear, devices embedded in shoes, controllers wearable as rings, and pedometers.

Some wearable devices are independent wearable devices in that they can operate as stand-alone mobile devices. Such a wearable device either includes some or all the capabilities of a mobile device described above or does not need or use the capabilities of a mobile device described above.

Other wearable devices are dependent wearable devices in that they operate in conjunction with a mobile device. Such a wearable device performs certain functions while in communication with a mobile device described above.

### SUMMARY

The illustrative embodiments provide a method, system, and computer program product for motion pattern based event detection using a wearable device. An embodiment includes a method for detecting events using a wearable device. The embodiment detects during a period beginning at a first time, using the wearable device, a pattern of a motion, the motion being in body part of a user on which the wearable device is worn. The embodiment records the pattern for the period, the pattern occurring over at least the period. The embodiment receives a collaborative information from the wearable device, the collaborative information defining a characteristic of the pattern. The embodiment associates the pattern and the collaborative information with an event. The embodiment detects during a second period beginning at a second time, the pattern and the collaborative information. The embodiment performs, responsive to detecting at the second time, an action associated with the event.

Another embodiment includes a computer program product for detecting events using a wearable device. The embodiment further includes one or more computer-readable tangible storage devices. The embodiment further includes program instructions, stored on at least one of the one or more storage devices, to detect during a period beginning at a first time, using the wearable device, a pattern of a motion, the motion being in body part of a user on which the wearable device is worn. The embodiment further includes program instructions, stored on at least one of the one or more storage devices, to record the pattern for the period, the pattern occurring over at least the period. The embodiment further includes program instructions, stored on at least one of the one or more storage devices, to receive a collaborative information from the wearable device, the collaborative information defining a characteristic of the pattern. The embodiment further includes program instructions, stored on at least one of the one or more storage devices, to associate the pattern and the collaborative information with an event. The embodiment further includes program instructions, stored on at least one of the one or more storage devices, to detect during a second period beginning at a second time, the pattern and the collaborative information. The embodiment further includes program instructions, stored on at least one of the one or more storage devices, to perform, responsive to detecting at the second time, an action associated with the event.

Another embodiment includes a computer system for detecting events using a wearable device. The embodiment further includes one or more processors, one or more computer-readable memories and one or more computer-readable storage devices. The embodiment further includes program instructions, stored on at least one of the one or more storage devices for execution by at least one of the one or more processors via at least one of the one or more memories, to detect during a period beginning at a first time, using the wearable device, a pattern of a motion, the motion being in body part of a user on which the wearable device is worn. The embodiment further includes program instructions, stored on at least one of the one or more storage devices for execution by at least one of the one or more processors via at least one of the one or more memories, to record the pattern for the period, the pattern occurring over at least the period. The embodiment further includes program instructions, stored on at least one of the one or more storage devices for execution by at least one of the one or more processors via at least one of the one or more memories, to receive a collaborative information from the wearable device, the collaborative information defining a characteristic of the pattern. The embodiment further includes program instructions, stored on at least one of the one or more storage devices for execution by at least one of the one or more processors via at least one of the one or more memories, to associate the pattern and the collaborative information with an event. The embodiment further includes program instructions, stored on at least one of the one or more storage devices for execution by at least one of the one or more processors via at least one of the one or more memories, to detect during a second period beginning at a second time, the pattern and the collaborative information. The embodiment further includes program instructions, stored on at least one of the one or more storage devices for execution by at least one of the one or more processors via at least one of the one or more memories, to perform, responsive to detecting at the second time, an action associated with the event.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts an example series of motion patterns for motion pattern based event detection using a wearable device in accordance with an illustrative embodiment;

FIG. 4 depicts a block diagram of an example manner of using combinations of motion patterns for event detection in accordance with an illustrative embodiment;

FIG. 5 depicts a block diagram of triggering actions from events in accordance with an illustrative embodiment; and

FIG. 6 depicts a flowchart of an example process for motion pattern based event detection using a wearable device in accordance with an illustrative embodiment.

### DETAILED DESCRIPTION

Within the scope of this disclosure, the term “wearable device” includes both independent and dependent types of wearable devices. Furthermore, in some cases, an operation described in an embodiment is implementable in a wearable device, a mobile device, or both. Additionally, in some cases, an operation described in an embodiment as an operation in a wearable device can be implemented as an operation in a mobile device, and vice-versa.

Generally, the illustrative embodiments recognize that a user's hand or arm (hand) is a very versatile limb and performs a range of motions that few other limbs or appendages, if any, can perform. Accordingly, the illustrative embodiments are described with respect to a limb, which comprises a hand or a part thereof of a user. A part of a hand can be, but is not limited to, a wrist, a finger, a joint in the hand, a muscle in the hand, a nerve in the hand, and the like, where physical motions or movements (collectively, “motion”) can be detected.

A motion detected at the user's hand or a part thereof may or may not necessarily be performed using the hand or the part thereof. For example, the act of walking is not performed using the hands but produces a swinging motion in the hands, which can be detected at the hand or a part thereof. On the other hand, swinging a golf club is a motion performed using a hand, and produces a golf-swing motion of the hand, which can be detected at the hand or a part thereof.

As another example, driving is an act that is performed using not only the hands but the feet as well. Some of the driving motions are performed by the hand and are detectable at the hand or a part thereof. Other driving motions are performed by the feet, or experienced by the torso, which can also be detected at the hand or a part thereof.

Within the scope of the illustrative embodiments, a motion is any motion that is detectable at a user's hand or a part of the user's hand. For example, a motion that is detectable by a wearable device worn on a user's hand or a part thereof is contemplated within the scope of the illustrative embodiments. Lifting or the arm, twisting of the wrist, tapping of a finger, pulsing or a nerve, and flexing of a muscle are some non-limiting examples of motions contemplated within the scope of the illustrative embodiments.

A pattern of a motion (motion pattern) according to the illustrative embodiments comprises a series of motions. A motion pattern can be, but need not necessarily be, a discrete motion in a discrete time. In other words, a motion pattern can be one or more motions spanning a finite length of time. Furthermore, a motion pattern can comprise repetitive performance of one motion, performance of different motions, or a combination thereof.

Additionally, a motion pattern can be, but need not necessarily be continuous. In other words, a motion pattern according to the illustrative embodiments can include zero or more pauses or periods of no motion, i.e., periods where no motion is detected at the user's hand or a part thereof even if a motion is being performed by another part of the user's body.

Presently, accelerometer-type sensors embedded in mobile devices or pedometer-type wearable devices are used to count the number of steps a user has walked, and to record such walk into a workout-logging application. Some other wearable devices, such as ring-type wearable television controllers, track singular or discrete motions to cause an operation of those devices.

The illustrative embodiments recognize that such detecting of discrete single motions is insufficient in several respects. For example, in most cases of presently available technologies, the user has to be positioned carefully relative to the wearable device, and the user has to perform a single motion or repeat a single motion, in order for the wearable device to detect the motion as an input for performing an operation.

For example, a pedometer requires a rhythmic repetition of a single back-and-forth motion observed at a user's leg to detect the motion as an input to record a walking step. As another example, a ring controller requires the user to perform a single ‘push’ motion in the air, with the finger on which the ring controller is worn, for the ring controller to detect that motion as an input to perform a ‘power On’ operation. Similarly, a single ‘swipe left’ motion in the air, with the finger on which the ring controller is worn, causes the ring controller to detect that motion as an input to perform a ‘change channel’ operation.

The illustrative embodiments recognize that users often use their hands or parts thereof to perform motions or patterns of motions that are more varied, more complex, or both, as compared to a single motion or a repetition thereof required by presently available wearable devices. For example, a user goes about the user's day in which the user naturally performs driving motions and motion patterns, writing motions and motion patterns, and motions and motion patterns associated with certain sports. Users also routinely and naturally perform certain motions and motion patterns associated with buying goods, conversing with other people, while talking on a phone, while waiting or contemplating, or while working on a particular task.

The illustrative embodiments recognize that presently available wearable devices are unable to detect such motions and motion patterns. The illustrative embodiments further recognize that presently available wearable devices are unable to identify such motions and motion patterns with certain events, or cause an action or operation to occur.

The illustrative embodiments used to describe the invention generally address and solve the above-described problems and other problems related to using a hand-wearable device to detect complex motions in a hand or a part thereof. The illustrative embodiments provide a method, system, and computer program product for motion pattern based event detection using a wearable device.

An embodiment can be implemented in hardware or firmware in a wearable device, or in a combination of a wearable device and a mobile device. An embodiment can also be implemented as software instructions.

For example, an embodiment can be implemented as software instructions to execute on an independent wearable device, such as in a smart watch that includes a processor and a memory. An embodiment can also be implemented as software instructions to execute in a combination of a dependent wearable device and a mobile device. For example, an embodiment can be implemented as software instructions to execute in a smart watch that operates in conjunction with a smartphone. Alternatively, an embodiment can be implemented as software instructions to execute in a smartphone that operates in conjunction with a smart watch.

An embodiment detects, at a user's hand or a part thereof, a motion pattern comprising one or more motions over a period. The embodiment associates the motion pattern with an event or activity (collectively, event). The event can be an activity that the user is performing using the motion pattern, an activity that the user wants to associate with the motion pattern, an activity that an embodiment associates with the motion pattern by default or pre-configuration, an activity unrelated to the motion pattern but associated with the motion pattern according to a rule or preference.

For example, the user may be golfing. An embodiment detects one or more motion patterns associated with a golf swing. The embodiment later detects one or more motion patterns associated with placing the golf bag into a vehicle. The embodiment later detects one or more motion patterns associated with driving the vehicle. Each of the motion pattern in the series of motion patterns occurs in the normal course of a user's other activities unrelated or unintended to provide specific motion inputs to a wearable device or a mobile device. Using all or a part of the series of motion patterns, an embodiment concludes that the user has finished golfing and is driving somewhere.

An embodiment further associates a motion pattern or a series of motion patterns with other information. For example, when an embodiment detects a motion pattern associated with a golf swing, the embodiment further determines, such as from a Global Positioning System (GPS) coordinates, that the swing was at the eighteenth hole.

From a shock in the muscle movement, an embodiment further determines that the swing actually hit the ball and was not a practice swing. From counting similar motion patterns with similar shocks, an embodiment determines that this was the fourth hitting swing at a par four eighteenth hole. From a history of the user's swings at the particular golf course, an embodiment further determines that the user probably made par on the hole, and walking away or placing the bag in a car and driving away is likely to occur next.

The above example is described to clarify certain operations of various embodiments, and not to imply a limitation. In a similar manner, the various embodiments can be configured for various use-cases, where motion patterns and other collaborative information and information sources enable an embodiment to make other use-case-specific determinations.

An embodiment further associates with the event an action or operation (collectively, action). In one embodiment, the action comprises an action performed at the wearable device or an associated mobile device. In another embodiment, the action comprises an action at a remote data processing system over a data network.

For example, if the user has finished golfing and is now driving, an embodiment can notify the user, on the wearable device, on the mobile device, or a combination thereof, about the next task on the user's list after golfing. As another example, if the user has finished golfing and is now driving, an embodiment can notify the user's partner or spouse that the user has finished golfing and is driving home.

Similarly, an embodiment can check the user's calendar data and notify an attendee of the next meeting that the user is finished with the previous task and is now driving towards the meeting venue. Whether the user is driving towards the user's home or another destination is easily ascertained from collaborative navigation information from a GPS component.

The specific actions are only examples to clarify certain operations of various embodiments, and not to imply a limitation. In a similar manner, the various embodiments can be configured for various use-cases, where motion patterns, associated events, and other collaborative information and information sources enable an embodiment to perform other use-case-specific actions.

A method of an embodiment described herein, when implemented to execute on a device or data processing system, comprises substantial advancement of the functionality of that device or data processing system in motion pattern based event detection using a wearable device. For example, where prior-art fails to recognize and act upon the user's non-device-specific motions, an embodiment incorporates the user's normal and routine motions and movements into actionable events and operations. Operating in a manner described herein, an embodiment allows a user to freely perform the motions and movements in the normal course of user's activities, learns to associate those motion patterns with certain events, and causes certain actions to occur in response thereto. Such manner of motion pattern-based actions is unavailable in presently available devices or data processing systems. Thus, a substantial advancement of such devices or data processing systems by executing a method of an embodiment simplifies and increases the utility of such devices or data processing systems while allowing the user to perform normal activities without performing any activities specifically for the device or data processing system.

The illustrative embodiments are described with respect to certain body parts, motions, movements, motion patterns, activities, actions, events, operations, use-cases, collaborative data, collaborative sources, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

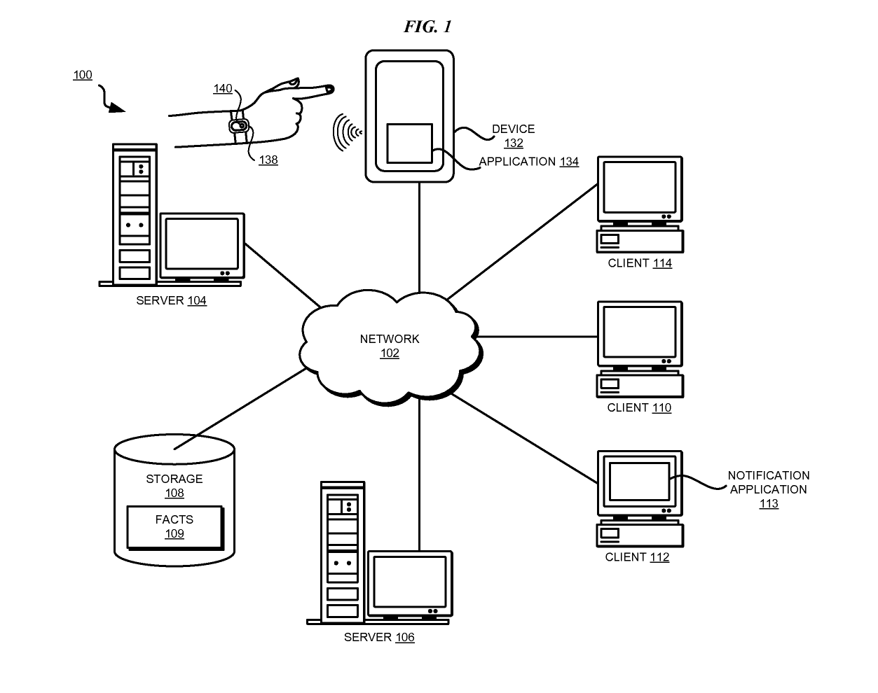

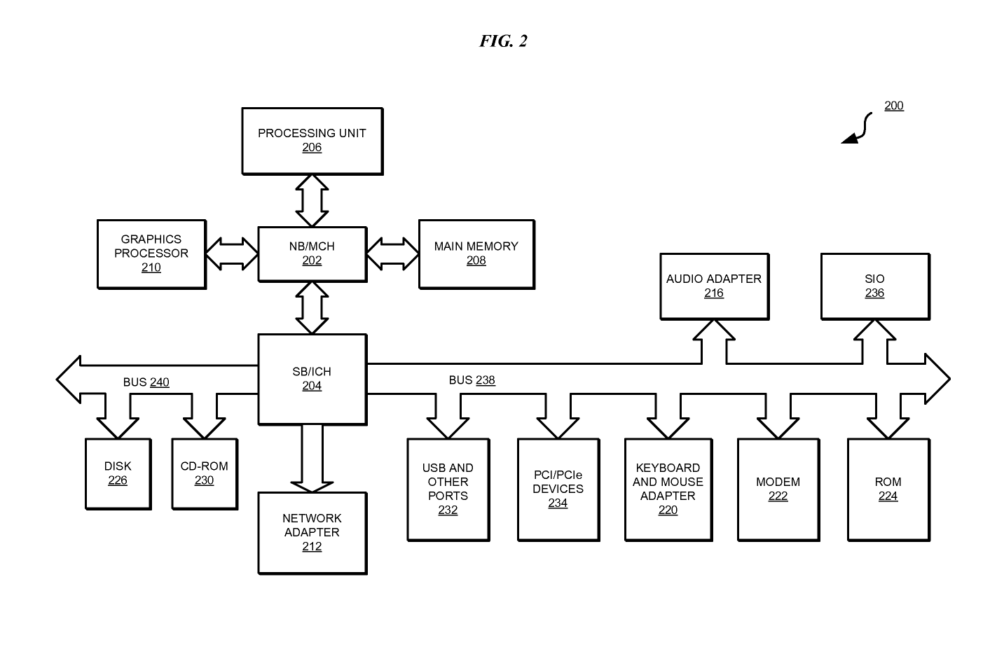

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device that can be configured for requesting entity reviews and analysis reports. Wearable device 138 can be either an independent wearable device or a dependent wearable device operating in conjunction with device 132, as described herein, such as over a wired or wireless data communication network. Application 134 implements an embodiment described herein to operate with wearable device 138, to perform an operation described herein, or both. Application 134 can be configured to use a sensor or other component (not shown) of device 132 to perform an operation described herein. Similarly, Application 140 implements an embodiment described herein to perform an operation described herein, to operate with device 132, or both. Application 140 can be configured to use a sensor or other component (not shown) of wearable device 138 to perform an operation described herein. Notification application 113 in client 112 is an example application relative to which application 134 or application 140 can operate. For example, application 134 or application 140 can send a notification to a second device over a data network, such as to client 112 over network 102, which application 113 can present using client 112. For example, wearable device 138 may be worn by a user and client 112 can be a user's home computer, an appliance at a place associated with the user or another person, a device associated with another person.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 or data processing system 138 in FIG. 1 in which computer usable program code or instructions implementing the processes of the illustrative embodiments may be located. Data processing system 200 is described as a computer only as an example, without being limited thereto. Implementations in the form of other devices, such as device 132 or device 138 in FIG. 1, may modify data processing system 200, modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 134 or application 140 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

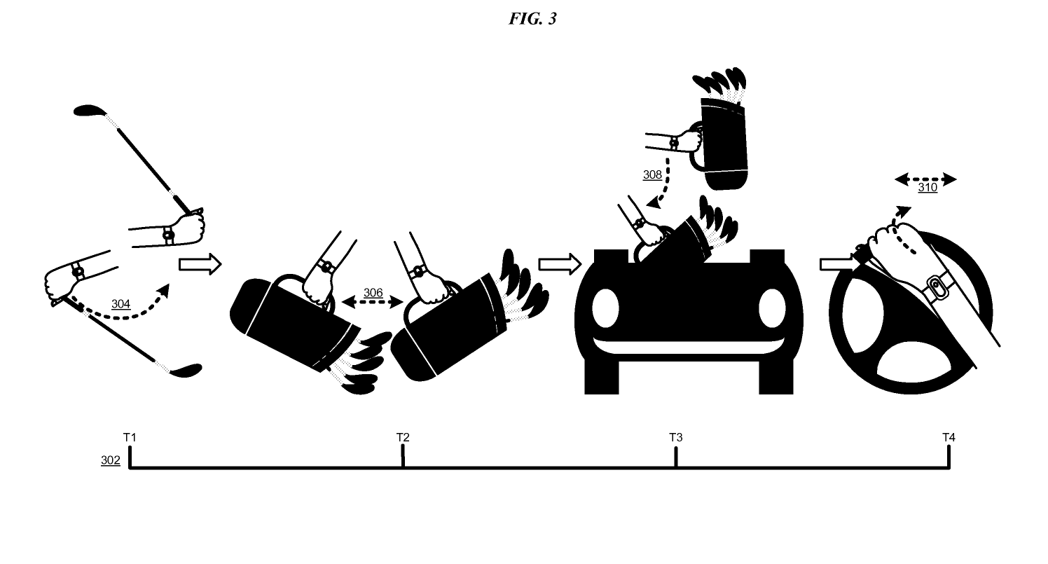

With reference to FIG. 3, this figure depicts an example series of motion patterns for motion pattern based event detection using a wearable device in accordance with an illustrative embodiment. Motion patterns 300 can be detected using application 140 in wearable device 138 in FIG. 1.

Consider the golfing example described earlier. Beginning at time T1, shown along example timeline 302, a user, who is wearing wearable device 138 on or relative to the user's hand, performs a swing with a golf club. The application identifies as motion pattern 304, the swinging motion of the hand detected by a sensor in wearable device 138.

Using one embodiment, the application associates motion pattern 304 with additional information, such as to confirm a characteristic of motion pattern 304, a location, time, amount, or other condition applicable to motion pattern 304, or a combination thereof. For example, another sensor in wearable device 138 detects the muscular strain from the weight of a swinging club and helps the application differentiate whether motion pattern 304 applies to an actual club swing, or a swing in the air using a pretend club. As another example, another sensor in wearable device 138 detects the shock from hitting an actual golf ball and helps the application differentiate whether motion pattern 304 applies to actually hitting a golf ball at a hole, or a practice swing with a club at the hole without hitting a ball.

Similarly, the application can use any number and type of components in wearable device 138, mobile device 132, or both, to collect other collaborative information. For example, a timer component of wearable device 138 or mobile device 132 can inform the application about a duration of motion pattern 304, or a duration of play during which motion pattern 304 occurred. As another example, a counter component of wearable device 138 or mobile device 132 can inform the application about a number of times motion pattern 304 occurred.

As another example, a GPS component of wearable device 138 or mobile device 132 can inform the application about a location of motion pattern 304, or a duration of play during which motion pattern 304 occurred. As another example, a calendar application in wearable device 138 or mobile device 132 can inform the application about a venue name, e.g., from a meeting appointment at a named golf course, where motion pattern 304 occurred.

These components are only described as example collaborative sources that can provide example types of collaborative information to an embodiment. Without departing the scope of the illustrative embodiments, many hardware, software, and firmware components can be similarly used in conjunction with an embodiment to qualify, improve, check, validate, characterize, or otherwise supplement a detected motion pattern.

At time T2, shown along timeline 302, the user, who is wearing wearable device 138 on or relative to the user's hand, performs a swinging motion with a golf bag, such as when walking and carrying the golf bag to a vehicle. The application identifies as motion pattern 306, the swinging motion of the hand detected by a sensor in wearable device 138.

Using one embodiment, the application associates motion pattern 306 with additional information, such as to confirm a characteristic of motion pattern 306, a location, time, amount, or other condition applicable to motion pattern 306, or a combination thereof. For example, a sensor in wearable device 138 detects the muscular strain from the weight of a swinging golf bag and helps the application differentiate whether motion pattern 306 applies to walking with a golf bag, or simply walking around for relaxing or another purpose.

Again, as an example, a GPS component can provide information about the distance, direction, or duration of the travel during which motion pattern 306 occurs. As another example, a pedometer or a pressure sensing component or application in wearable device 138 or mobile device 132 can provide collaborating information about whether the user is walking with a weight in hand or has the hands free.

At time T3, shown along timeline 302, the user, who is wearing wearable device 138 on or relative to the user's hand, performs a lifting and releasing motion with a golf bag, such as when placing the golf bag in a vehicle. The application identifies as motion pattern 308, the lifting and releasing motion of the hand detected by a sensor in wearable device 138.

Using one embodiment, the application associates motion pattern 308 with additional information, such as to confirm a characteristic of motion pattern 308, a location, time, amount, or other condition applicable to motion pattern 308, or a combination thereof. For example, a sensor in wearable device 138 detects the muscular strain from lifting the weight of a swinging golf bag followed by a release of that strain, and helps the application differentiate whether motion pattern 308 applies to actually placing a golf bag into a vehicle, or merely a stretching action.

Again, as an example, a pressure sensing component or application in wearable device 138 or mobile device 132 can provide collaborating information about whether the user is lifting and releasing a weight or has the hands free.

At time T4, shown along timeline 302, the user, who is wearing wearable device 138 on or relative to the user's hand, performs a steering motion with a steering wheel, such as when driving a vehicle. The application identifies as motion pattern 310, the gripping and steering motion of the hand detected by a sensor in wearable device 138.

Using one embodiment, the application associates motion pattern 310 with additional information, such as to confirm a characteristic of motion pattern 310, a location, time, amount, or other condition applicable to motion pattern 310, or a combination thereof. For example, a sensor in wearable device 138 detects the muscular strain from gripping a solid circular object followed by one or more turning motions while gripping the object, and helps the application differentiate whether motion pattern 310 applies to actually driving a vehicle, or perhaps drawing a circle on a paper.

Again, as an example, a temperature sensing component or application in wearable device 138 or mobile device 132 can provide collaborating information about whether the user is in an air-conditioned space such as a vehicle or outdoors. As another example, a GPS component or a navigation application in wearable device 138 or mobile device 132 can provide collaborating information about whether the user traveling at a vehicular velocity or is stationary.

The application can use motion patterns 304, 306, 308, and 310, individually or in some combination to determine the occurrence of one or more events. For example, when the series of motion patterns 304 and 306 repeats without motion pattern 308 occurring, the application may detect that the event of continued golfing is occurring.

Similarly, motion patterns 308 and 310 occurring before motion patterns 304 or 306 may cause the application to detect an event that the user is driving to a golf course before the golfing activity begins. Several occurrences of motion pattern 304 at the same location and without the strain of hitting a golf ball may similarly indicate the event of practice swings. Motion pattern 306, followed by releasing of the strain from carrying the golf bag, followed by a motion pattern (not shown) of again lifting the golf bag, with suitable collaborating information, may indicate that the user sat down at a the golf course clubhouse at the end of a game.

The various embodiments can be configured according to different use-cases, other than the golfing example described here, to detect other motion patterns, other combinations of motion patterns, and other events. Such other configurations are contemplated within the scope of the illustrative embodiments.

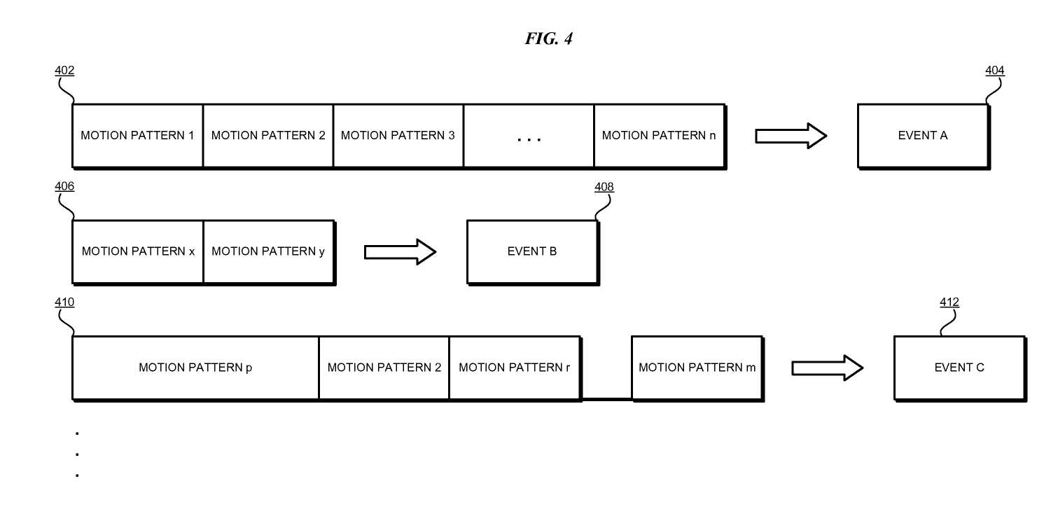

With reference to FIG. 4, this figure depicts a block diagram of an example manner of using combinations of motion patterns for event detection in accordance with an illustrative embodiment. Any motion pattern described with respect to FIG. 3 can be used in combination 402.

Combination 402 comprises any number and type of motion patterns. For example, motion pattern labeled “motion pattern 1” may be motion pattern 304 in FIG. 3, motion pattern labeled “motion pattern 2” may be another instance of motion pattern 304 in FIG. 3, motion pattern labeled “motion pattern 3” through motion pattern n−1 may be repeats of motion pattern 306 in FIG. 3, and motion pattern labeled “motion pattern n” may be motion pattern 308 in FIG. 3.

An application implementing an embodiment associates combination 402 with event 404 labeled “event A”. For example, in one embodiment, the application accepts a user input to identify event 404, and form the association between combination 402 and event 404. In another example embodiment, the application uses a pre-determined profile to identify event 404, or to form the association between combination 402 and event 404, or a combination thereof.

In another example embodiment, the association between combination 402 and event 404 may have been previously established as described above. Accordingly, when the application observes combination 402, the application invokes event 404, or concludes that event 404 is occurring or has occurred.

Combination 406 is another example combination of one or more motion patterns. An application implementing an embodiment associates combination 406 with event 408 labeled “event B”. Combination 410 is another example combination of one or more motion patterns. An application implementing an embodiment associates combination 410 with event 412 labeled “event C”.

As described earlier, the motion patterns in combination 406 may be unique motion pattern instances, repetitive motion patterns, singular or discrete motions, continuous motions, prolonged motions occurring over a period, or some combination thereof. Combinations 402, 406, and 408 may be for different events in the same use-case, or for different events in different use-cases, or some combination thereof.

An embodiment allows the application to detect any number and types of combinations, and associate them with any number and types of events, in any number and types of use-cases without limitations. A combination can be singularly associated with an event, multiple combinations can be associated with the same event, or multiple events can be associated with the same combination, multiple combinations can be associated with multiple events, or any suitable mix thereof. An embodiment can use suitable collaborating information to identify an applicable association, where plurality of associations between motion pattern combinations and events are described.

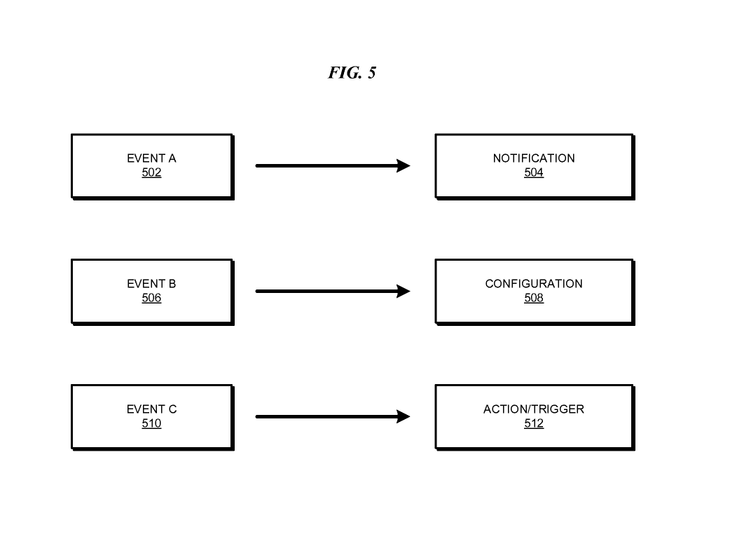

With reference to FIG. 5, this figure depicts a block diagram of triggering actions from events in accordance with an illustrative embodiment. Event 502 is an example of event 404 in FIG. 4.

An application implementing an embodiment detects event 502. The application causes action 504 to occur, which for example notifies someone with a message. Similarly, when the application detects event 506, the application causes action 508 to occur. Action 508, for example, changes a configuration. For example, action 508 may change a device setting in a wearable device or a mobile device where the application may be executing.

As an example, if the event 506 indicates that the user is driving, action 508 may cause a call to the user's mobile device to go straight to voicemail. As another example, if the event 506 indicates that the user is driving, action 508 may cause a call to the user's wearable device to go into a different mode, to detect different motions using a different set of sensors. As another example, if the event 506 indicates that the user is driving home, action 508 may cause an appliance in the user's home to turn on.

Generally, any event, such as event 510, can trigger any suitable action, such as action 512, within the scope of the illustrative embodiments. From this disclosure, many other notifications, configuration changes, and actions will be conceivable to those of ordinary skill in the art and the same are contemplated within the scope of the illustrative embodiments

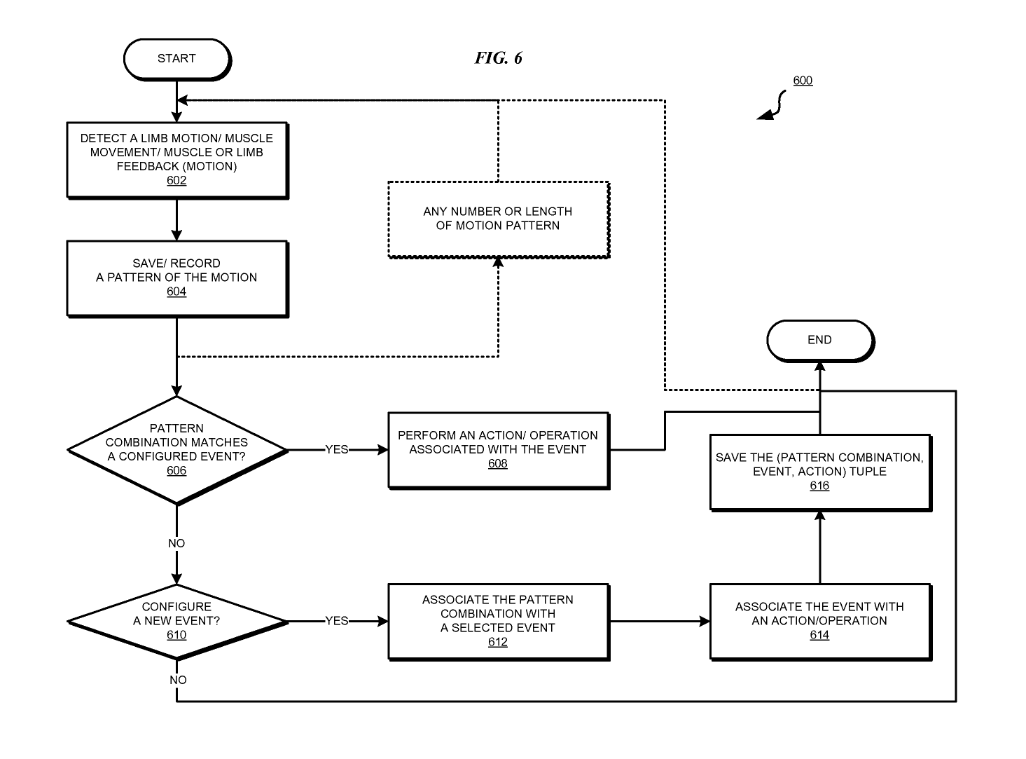

With reference to FIG. 6, this figure depicts a flowchart of an example process for motion pattern based event detection using a wearable device in accordance with an illustrative embodiment. Process 600 can be implemented in application 134 or application 140 in FIG. 1.

The application, using a wearable device, detects a motion in a limb, such as a hand, on or relative to which the wearable device is worn (block 602). The application saves or records a pattern of the motion (block 604). The application detects and records any number or length of motion patterns in this manner.

The application determines whether the recorded combination of one or more motion patterns matches a configured event (block 606). The matching in block 606 can, but need not be an exact match, and can be a match within a tolerance value.

If the combination matches a configured event, e.g., when the combination has been previously observed and associated with an event (“Yes” path of block 606), the application performs an action or operation associated with the matching event (block 608). If the combination does not match a configured event within a tolerance, e.g., when the combination has not been previously observed or associated with an event (“No” path of block 606), the application determines whether the combination should be configured or associated with an event (block 610).

If the application determines that the combination should not be configured or associated with an event (“No” path of block 610), the application ends process 600 thereafter, or returns to block 602 to detect another motion pattern. For example, a user may choose to ignore certain motion patterns and not associate those motion patterns alone or in combination with other motion patterns with any events.

If the application determines that the combination should be configured or associated with an event (“Yes” path of block 610), the application associates the combination with a selected event (block 612). For example, in one embodiment, the user provides an input to select a suitable event to associate with the combination of the motion patterns.

The application associates the event of block 612 with a selected action or operation (block 614). For example, in one embodiment, the user provides an input to select a suitable action to associate with the selected event, to perform the action or operation when the combination of the motion patterns is observed in the future.

The application saves the tuple comprising the combination of the motion patterns, the associated event, and the action configured for the event (block 616). The application ends process 600 thereafter, or returns to block 602 to detect another motion pattern.

Thus, a computer implemented method, system or apparatus, and computer program product are provided in the illustrative embodiments for motion pattern based event detection using a wearable device. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for detecting events using a wearable device, the method comprising:
detecting during a period beginning at a first time, using the wearable device, a pattern of a motion, the motion being in body part of a user on which the wearable device is worn;
recording the pattern for the period, the pattern occurring over at least the period;
receiving a collaborative information from the wearable device, the collaborative information defining a characteristic of the pattern;
associating the pattern and the collaborative information with an event;
detecting during a second period beginning at a second time, the pattern and the collaborative information; and
performing, responsive to detecting at the second time, an action associated with the event.

2. The method of claim 1, wherein the detecting is performed at an application executing using a processor and a memory in the wearable device.

3. The method of claim 1, wherein the detecting is performed at an application executing using a processor and a memory in a mobile device, the mobile device being in communication with the wearable device.

4. The method of claim 1, wherein the body part comprises a hand, further comprising:
detecting, using a sensor in the wearable device, a movement of a muscle in the hand, a measurement of the movement forming the collaborative information.

5. The method of claim 1, wherein the body part comprises a hand, further comprising:
receiving, from a sensor in the wearable device, a measurement of a strain in a muscle in the hand, the measurement forming the collaborative information.

6. The method of claim 1, wherein the body part comprises a hand, further comprising:
receiving, from a sensor in the wearable device, a measurement of a shock during a movement of a muscle in the hand, the measurement forming the collaborative information.

7. The method of claim 1, further comprising:
receiving a second collaborative information from one of (i) the wearable device, and (ii) a mobile device operating in conjunction with the wearable device;
associating the pattern and the second collaborative information with a second event.

8. The method of claim 1, further comprising:
detecting during the period beginning at the first time, a second pattern of a second motion, wherein the associating further associates the second pattern with the event.

9. The method of claim 1, wherein the collaborative information comprises information from a calendaring application, and wherein an action related to the event comprises notifying a participant identified in the information from the calendar.

10. The method of claim 1, wherein the method is embodied in a computer program product comprising one or more computer-readable tangible storage devices and computer-readable program instructions which are stored on the one or more computer-readable tangible storage devices and executed by one or more processors.

11. The method of claim 1, wherein the method is embodied in a computer system comprising one or more processors, one or more computer-readable memories, one or more computer-readable tangible storage devices and program instructions which are stored on the one or more computer-readable tangible storage devices for execution by the one or more processors via the one or more memories and executed by the one or more processors.

12. A computer program product for detecting events using a wearable device, the computer program product comprising:
one or more computer-readable tangible storage devices;
program instructions, stored on at least one of the one or more storage devices, to detect during a period beginning at a first time, using the wearable device, a pattern of a motion, the motion being in body part of a user on which the wearable device is worn;
program instructions, stored on at least one of the one or more storage devices, to record the pattern for the period, the pattern occurring over at least the period;
program instructions, stored on at least one of the one or more storage devices, to receive a collaborative information from the wearable device, the collaborative information defining a characteristic of the pattern;
program instructions, stored on at least one of the one or more storage devices, to associate the pattern and the collaborative information with an event;
program instructions, stored on at least one of the one or more storage devices, to detect during a second period beginning at a second time, the pattern and the collaborative information; and
program instructions, stored on at least one of the one or more storage devices, to perform, responsive to detecting at the second time, an action associated with the event.

13. The computer program product of claim 12, wherein the program instructions to detect are executed at an application executing using a processor and a memory in the wearable device.

14. The computer program product of claim 12, wherein the program instructions to detect are executed at an application executing using a processor and a memory in a mobile device, the mobile device being in communication with the wearable device.

15. The computer program product of claim 12, wherein the body part comprises a hand, further comprising:
program instructions, stored on at least one of the one or more storage devices, to detect, using a sensor in the wearable device, a movement of a muscle in the hand, a measurement of the movement forming the collaborative information.

16. The computer program product of claim 12, wherein the body part comprises a hand, further comprising:
program instructions, stored on at least one of the one or more storage devices, to receive, from a sensor in the wearable device, a measurement of a strain in a muscle in the hand, the measurement forming the collaborative information.

17. The computer program product of claim 12, wherein the body part comprises a hand, further comprising:
program instructions, stored on at least one of the one or more storage devices, to receive, from a sensor in the wearable device, a measurement of a shock during a movement of a muscle in the hand, the measurement forming the collaborative information.

18. The computer program product of claim 12, further comprising:
program instructions, stored on at least one of the one or more storage devices, to receive a second collaborative information from one of (i) the wearable device, and (ii) a mobile device operating in conjunction with the wearable device;
program instructions, stored on at least one of the one or more storage devices, to associate the pattern and the second collaborative information with a second event.

19. The computer program product of claim 12, further comprising:
program instructions, stored on at least one of the one or more storage devices, to detect during the period beginning at the first time, a second pattern of a second motion, wherein the associating further associates the second pattern with the event.

20. A computer system for detecting events using a wearable device, the computer system comprising:
one or more processors, one or more computer-readable memories and one or more computer-readable storage devices;
program instructions, stored on at least one of the one or more storage devices for execution by at least one of the one or more processors via at least one of the one or more memories, to detect during a period beginning at a first time, using the wearable device, a pattern of a motion, the motion being in body part of a user on which the wearable device is worn;
program instructions, stored on at least one of the one or more storage devices for execution by at least one of the one or more processors via at least one of the one or more memories, to record the pattern for the period, the pattern occurring over at least the period;
program instructions, stored on at least one of the one or more storage devices for execution by at least one of the one or more processors via at least one of the one or more memories, to receive a collaborative information from the wearable device, the collaborative information defining a characteristic of the pattern;
program instructions, stored on at least one of the one or more storage devices for execution by at least one of the one or more processors via at least one of the one or more memories, to associate the pattern and the collaborative information with an event;
program instructions, stored on at least one of the one or more storage devices for execution by at least one of the one or more processors via at least one of the one or more memories, to detect during a second period beginning at a second time, the pattern and the collaborative information; and
program instructions, stored on at least one of the one or more storage devices for execution by at least one of the one or more processors via at least one of the one or more memories, to perform, responsive to detecting at the second time, an action associated with the event.
